(19) United States
(12) Patent Application Publication
(10) Pub. No.: US 2024/0361041 A1
(43) Pub. Date: Oct. 31, 2024

(54) SOLAR WATER HEATING PANEL

(71) Applicant: I.P.U. INDUSTRIES LTD., Kiryat Gat (IL)

(72) Inventor: Eyal BEN-AMI, Kiryat Gat (IL)

(21) Appl. No.: 18/687,857

(22) PCT Filed: Sep. 1, 2022
(86) PCT No.: PCT/IL2022/050960

§ 371 Date: Feb. 29, 2024

(30) Foreign Application Priority Data
Sep. 1, 2021 (IL) 286063

(51) Int. Cl. F24S 10/25; F24S 50/40

(52) U.S. Cl. CPC F24S 10/25; F24S 50/40

(57) ABSTRACT

A device and system for solar water heating that comprises a water heating panel with improved heat transfer. The water heating panel comprises a pipe distributer and a manifold having two separate portions comprising an inlet portion and an outlet portion and: a plurality of fluid heating pipes that are configured to be in fluid communication between the manifold and the pipe distributer.

### FIELD OF THE INVENTION

The present invention relates to a device and system for solar water heating panel, and in particular, to such a device and system and in which the heating panel features improved heat transfer.

### BACKGROUND OF THE INVENTION

Solar based water heating systems that including panels and water tanks and/or reservoirs are used in water heating for home use. Such systems generally include a water tank for receiving cold water at a lower portion thereof and receiving hot water from the solar panel at an upper portion thereof. Accordingly, in current system cold water enters a solar panel at a lower portion of the solar panel and hot water exit at a top portion of the solar panel that is in fluid communication with the top portion of the fluid tank. Accordingly, current solar based water heaters function by employing a temperature gradient between a lower portion and an upper portion of the water tank and solar panel respectively.

### SUMMARY OF THE INVENTION

There is an unmet need for, and it would be highly useful to have, a solar water heating panel and associated system capable of improving the heating efficiency of state of the art solar power water heating systems.

Embodiments of the present invention provide a water heating solar panel featuring a split manifold having an inlet portion and an outlet portion. In embodiments the manifold is split between inlet portion and outlet portion according to a ratio of from about 20:80 (inlet to outlet) and up to a ratio of about 50:50 (inlet to outlet).

In embodiments, the solar panel features a plurality of water heating pipes that are disposed between and in fluid communication between a manifold and a water distributing pipe. In embodiments each water heating pipe features a first end that is configured to be coupled with the manifold along a dedicated recess therefor. In embodiments each water heating pipe features a second end that is configured to be coupled with the water distributer pipe along a dedicated recess therefor.

In embodiments the water heating pipes are a concentric multilayered pipe comprising an outer layer, an intermediate layer and an internal layer having an internal lumen. In some embodiments heating pipes are configured to have an external diameter of about 10 to 16 mm (millimeters). In embodiments, the water heating pipes are configured to have an internal pipe lumen having an internal diameter from about 4-8 mm (millimeters).

In embodiments the intermediate layer may be provided from thermally conductive materials to facilitate heating of water flowing within the internal lumen.

In embodiments the outer layer and inner layer may for example be provided from materials for example including but not limited to plastic, polymers, polyethylene, or the like. In embodiments the inner layer preferably may be provided from dark and/or opaque material preferably to facilitate and/or improve heat transfer. In embodiments the outer layer may be provided from clear and/or transparent materials so as to allow increase heat penetration to the inner lumen of the water heating pipes.

In embodiments the solar panel comprises a housing including an upper cover and a lower cover. In embodiments, the upper cover is preferably provided from clear and/or transparent material(s), for example including but not limited to glass, polycarbonate, polymers, or the like. In embodiments the upper cover may be coating to enhance heat transfer process. In some embodiments the coating may for example include an ultraviolet (UV) selective coating so as to filter any harmful UV rays.

In embodiments, the lower cover may be provided and/or incorporate insulating materials for example including but not limited to air gaps within the lower cover.

In some embodiments, the solar panel may further comprise a heat promoting surface, for example including but not limited to reflective surface, to maximize and/or amplify the solar heating effect. In some embodiments the heat promoting surface may be provided with a corrugated surface for receiving and/or fitting with the water heating pipes.

Unless otherwise defined, all technical and scientific terms used herein have the same meaning as commonly understood by one of ordinary skill in the art to which this invention belongs. The materials, methods, and examples provided herein are illustrative only and not intended to be limiting.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic block diagram of an exemplary device and system according to the present invention;

FIG. 2 is a schematic illustrative diagram of an exemplary device and system according to the present invention;

FIG. 3 is a schematic illustration of a solar panel according to embodiments of the present invention showing an exploded view thereof;

FIG. 4 is a schematic illustration of a portion of a solar panel according to embodiments of the present invention showing a partial sectional view;

FIG. 5A-B show a schematic illustrative view of the pipe according to embodiments of the present invention. FIG. 5A showing a sectional view; and FIG. 5B showing a perspective layered side view;

FIG. 6A-B show a schematic illustrative view of the manifold according to embodiments of the present invention. FIG. 6A showing a side view; and FIG. 6B showing a sectional side view;

FIG. 6C shows a schematic illustrative view of the fluid distributer according to embodiments of the present invention; and

FIG. 7 shows a schematic illustrative view of a plurality of solar panels connected in series according to embodiments of the present invention; and

FIG. 8A is a schematic illustration of a solar panel assembly according to embodiments of the present invention showing an exploded view thereof;

FIG. 8B is a schematic illustration of a spiral pipes utilized with a solar panel assembly according to embodiments of the present invention;

FIG. 9A is a schematic illustration of a solar panel assembly featuring an optional vacuum module according to embodiments of the present invention; and

FIG. 9B is a schematic illustration of a solar panel assembly featuring an optional vacuum module according to embodiments of the present invention.

### DESCRIPTION OF THE PREFERRED EMBODIMENTS

The principles and operation of the present invention may be better understood with reference to the drawings and the accompanying description.

The following figure reference labels are used throughout the description to refer to similarly functioning components are used throughout the specification hereinbelow.
10 water tank;
20 fluid flow controller;
50 solar water heating system;
100 solar water heating panel;
102 water heating pipes;
102a internal diameter;
102b intermediate layer;
102c external layer;
102s spiral water heating pipes;
102L left handed/counter-clockwise spiral pipe;
102R right handed/clockwise spiral pipe;
104 distribution pipe/distributer;
106 distributer pipe receiving recess;
110 manifold;
112 manifold inlet;
114 manifold outlet;
115 manifold splitter/divider;
116 manifold pipe receiving recess;
120 housing;
122 upper cover;
124 lower cover;
126 heat promoting surface;
130 vacuum module;
132 vacuum pipe;
134 first vacuum valve;
135 venturi assembly;
136 second vacuum valve;
138 venturi pipe;

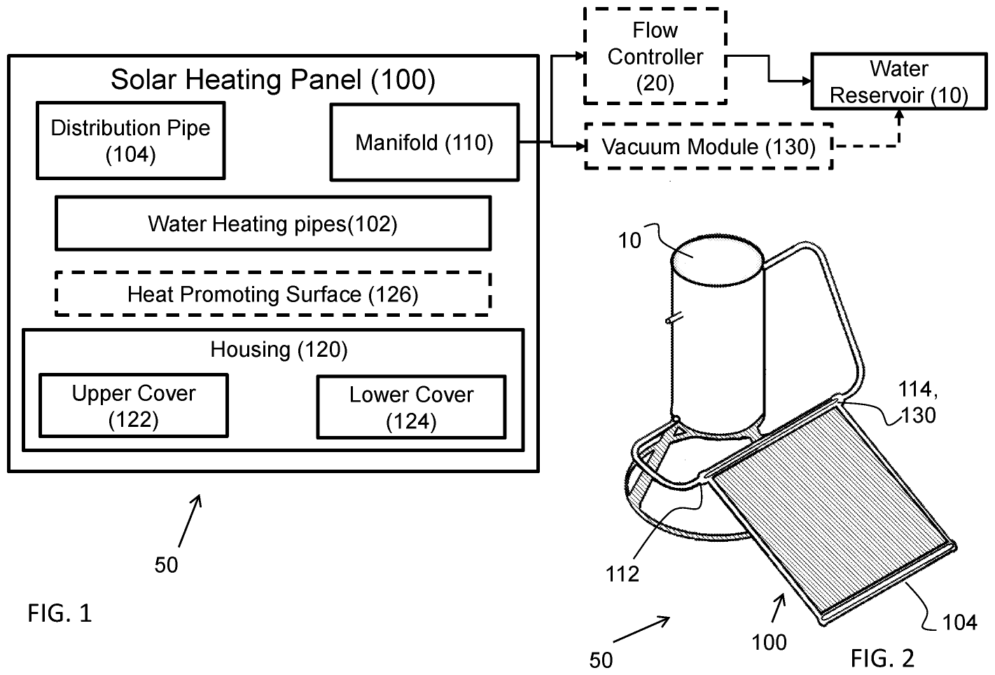

Collectively referring to the drawings, FIG. 1-9B that show a solar water heating panel 100 and associated system 50 according to embodiments of the present invention.

FIG. 1 shows a schematic block diagram of an exemplary device in the form of a solar water heating panel 100 and associated system 50 according to embodiments. FIG. 2 shows an illustrative depiction of system 50 having a fluid tank 10 in fluid communication with panel 100 according to embodiments of the present invention.

System 50 comprises at least one solar water heating panel 100 in fluid communication with a water tank and/or reservoir 10. In optional embodiment, a fluid flow controller 20, as depicted in broken line, may be utilized to control the flow between reservoir 10 and panel 100. In embodiments flow controller 20 may for example be provided in the form of a valve. In some embodiments the valve may for example be provide din the form of a temperature sensitive wax valve. In some embodiments the valve may for example be provided in the form of a pressure sensitive ball valve. In some embodiments flow controller 20 may be remotely controllable.

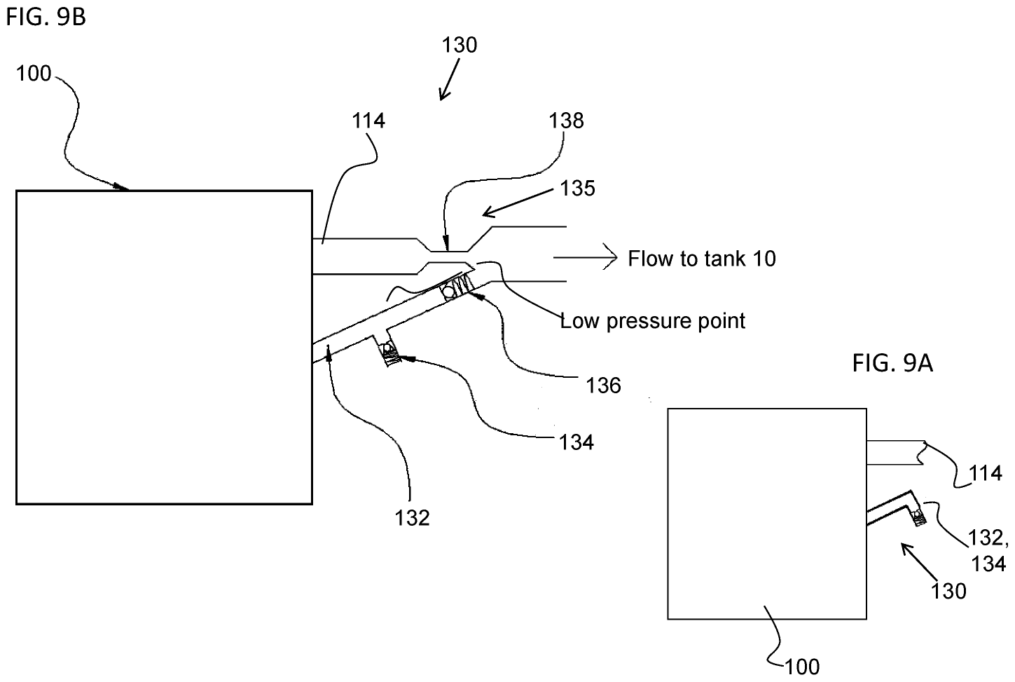

In embodiments system 50 may further comprise an optional vacuum module 130, depicted in broken line, that may be connected to panel 100, for example as shown in greater details in FIG. 9A-B. In some embodiments, vacuum module 130 may be coupled to solar panel 110, for example as shown in FIG. 9A, and may optionally be configured to be further coupled with water outlet of panel 110, for example as shown in FIG. 9B, utilizing a venturi assembly 135.

FIG. 1 shows the water heating solar panel 100 that preferably comprises: a manifold 110 having an inlet portion 112 and an outlet portion 114; a pipe distributer 104, a plurality of water heating pipes 102 in fluid communication between the manifold 110 and the distributer 104; a housing 120 including an upper cover 122 and a lower cover.

As shown, solar panel 100 may be functionally associated with a vacuum module 130, so as to generate a vacuum environment within solar panel housing 120 of solar panel 100. In an optional embodiment, vacuum module 130 may be directly linked with a portion of housing 120 so as to generate a vacuum environment therein, for example as shown in FIG. 9A. In an optional embodiment, the vacuum module 130 preferably utilized to generate a vacuum environment within housing 120 of solar panel 100, may further comprise a venturi assembly 135, for example as shown in FIG. 9B, to maintain the vacuum environment within housing 120 of panel 100, during use.

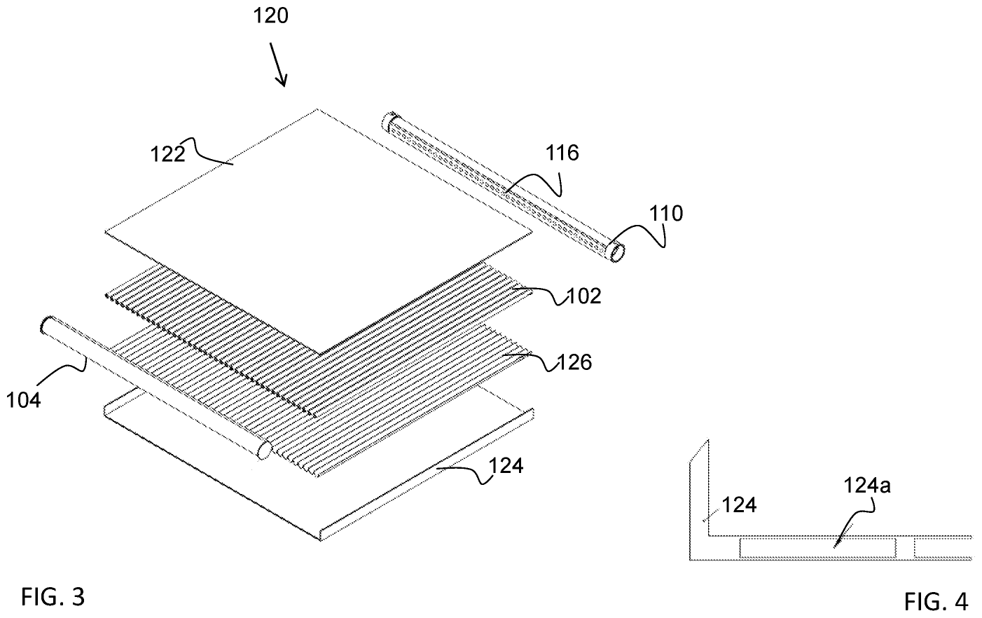

In some embodiments the housing 120, for example a shown in FIG. 3, for solar panel 100 may further comprise a heat promoting surface 126 disposed adjacent to and/or coupled to the plurality of water heating pipes 102. In some embodiments the heat promoting surface 126 may comprise a reflective surface. In some embodiments, the reflective surface may be disposed below and house at least a portion of the plurality of pipes 102.

In some embodiments the lower cover 124 may be provided in the form of an is an insulated cover, for example as shown in FIG. 4. In embodiments, the lower cover 124 may comprise a plurality of air gaps 124a, for example as show in FIG. 4, so as to service an insulating material.

In embodiments the upper cover 122 may be preferably provided from clear and/or transparent material(s), for example including but not limited to glass, polycarbonate, polymers, or the like. In embodiments the upper cover 122 may further feature a coating, optionally and preferably to enhance heat transfer process. In some embodiments the coating may for example include but is not limited to an ultraviolet (UV) selective coating so as to filter any harmful UV rays therein protecting pipes 102.

In embodiments, the manifold 110, for example as shown in FIG. 6A-B, features a divider 115 that defines an inlet portion 112 and outlet portion 114, as best seen in FIG. 6B. In embodiments, divider 115 divides manifold 110 in an inlet to outlet ratio such that the inlet assumes from about 20% and up to 50% of the manifold length and/or volume; while the outlet assumes a length of about 50% to 80% of the manifold length and/or volume. Accordingly, divider 115 defines the manifold having an inlet:outlet ratio of at least 20:80 ratio and up to about 50:50 ratio.

In embodiments the inlet to outlet ratio may for example be selected from at least one of the following ratios: 20:80, 25:75, 30:70, 35:65; 40:60, 45:55 or 50:50, or the like.

As best seen in FIG. 3, the solar panel features a plurality of water heating pipes that are disposed between and in fluid communication between manifold 110 and a distributing pipe 104. In embodiments each water heating pipe features a first end that is configured to be coupled with the manifold along a dedicated recess therefor 116, for example as seen in FIG. 6A. In embodiments each water heating pipe features a second end that is configured to be coupled with the water distributer pipe 104 along a dedicated recess therefor 106, for example as shown in FIG. 6C.

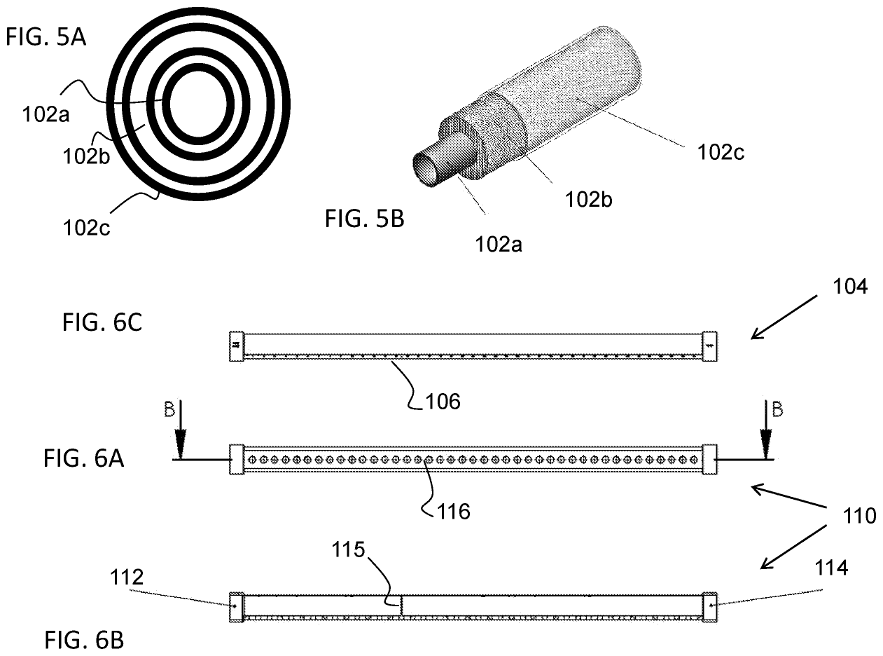

As best seen in FIG. 5A-B showing the water heating pipe 102 according to the present invention, the plurality of water heating pipes 102 are a multi-layer concentric pipe, FIG. 5A, featuring: an internal water flowing lumen 102a, an intermediate layer 102b configured to surrounding the internal lumen 102a and an outer layer 102c surrounding the intermediate layer 102b.

In embodiments, the intermediate layer 102b may be a thermally conductive material.

In embodiments, the pipe 102 may be provided with an external diameter of from about 10 mm and up to about 16 mm, as depicted by external layer 102c.

In embodiments, the pipe may be provided with an internal diameter of from about 4 mm and up to about 8 mm, as depicted by the internal lumen 102a.

In embodiments, the internal lumen 102a may further feature a variable internal diameter along its length. Optionally and preferably the variable internal diameter varies by about 1 mm.

In embodiments the outer layer 102c and inner layer 102a may for example be provided from materials for example including but not limited to plastic, polymers, polyethylene, or the like. In embodiments the inner layer 102a may be provided from dark and/or opaque material preferably to facilitate and/or improve heat transfer.

In embodiments the outer layer 102c may be provided from clear and/or transparent materials so as to allow increase heat penetration to the inner lumen of the water heating pipes 102.

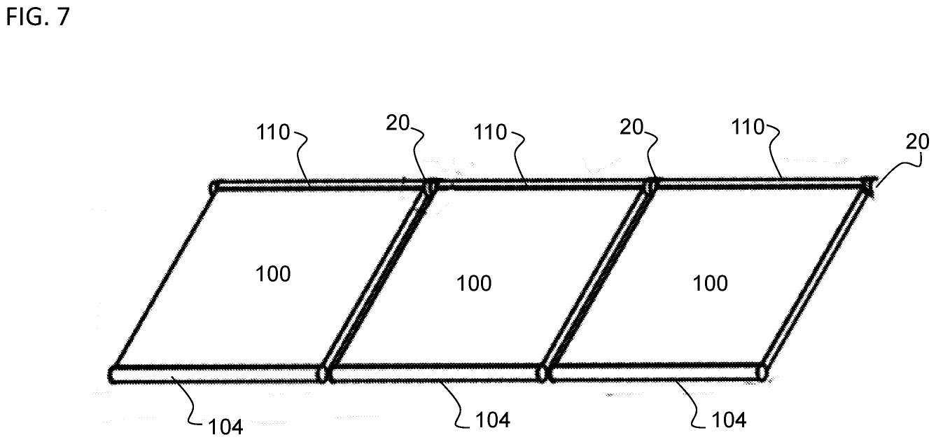

In embodiments two or more solar panels 100 according to the present invention may be coupled in fluid communication with one another, for example as shown in FIG. 7. As shown, solar panels 100 may be coupled in fluid communication in series.

FIG. 3 shows an exploded view of panel 100 so as to reveal the internal members as described above, while further showing the layered relationship between them.

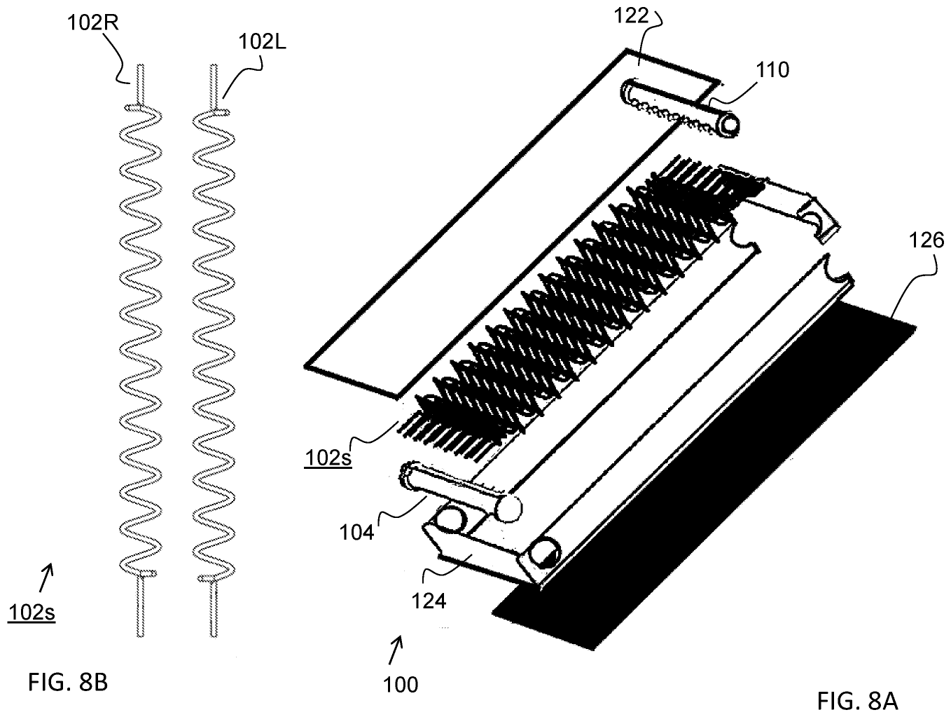

FIG. 8A-B show a further embodiment of panel 100 according to embodiments of the present invention. Panel 100 depicted in FIG. 8A shows an exploded view of panel 100 similar to that shown in FIG. 3, however FIG. 8A utilizes a spiral pipe assembly 102s as the heating pipe for panel 100. Accordingly, the housing for panel 100 is configured to accommodate the spiral pipe assembly 102s, however, the functionality is the same as that described above with respect to FIG. 1-7. Accordingly, inlet manifold 110, distribution pip 104, upper cover 122, lower cover 124, and heat promoting surface 126, collectively function as previously described. Panel 100 of FIG. 8A is characterized in that the water heating pipes 102 are provided with a spiral configuration 102s as shown in FIG. 8B. Spiral pipes 102s are provided in a clockwise 102R and counter-clockwise 102L configuration and most preferably configured to cooperate with one another, as shown in FIG. 8A. In embodiments, spiral pipes 102s are constructed and configured to function similar to pipe 102 as previously described comprising the heat promoting layering as shown in FIG. 5A-B. The spiral pipe 102s configuration provides for significantly increasing the surface area utilized to heat water. A water panel 100 featuring spiral pipe 102s, either right handed 102R or left handed pipe 102R, features a longer conducting surface that by a factor of about 1.6, when compared to that of a corresponding straight pipe 102, as effectively a spiral pipe 102s, 102R, 102L is about 1.6 times the length of a corresponding straight pipe 102. Accordingly, by way of utilizing a spiral pipe assembly 102s comprising a right handed pipe 102R and a left handed pipe 102L provides for increasing the overall heating surface by at least a factor of 2.5 or more, at least when compared to a straight tubular pipe 102, previously described.

In embodiments a spiral pipe 102s for example as shown, refers to a tubular pipe having a fluid conducting internal lumen, having a spiral and/or helical and/or coiled and/or spring-like configuration that may be configured to turn and/or advance in a clockwise 102R and/or counterclockwise 102L direction.

In embodiments, the dimensional configuration of the spiral pipe 102s, may be determined and/or selected according to at least one or more parameters selected from: number of turns, length, external diameter, internal diameter, pitch, height, any combination thereof, or the like parameters.

In embodiments, the dimensional configuration of the spiral pipe 102R, 102L may be configured relative to one another such that may form a spiral pipe assembly and correspond and/or fit with one another to maximize space utilization, for example by controlling the correlating parameters selected from at least one or more of: number of turns, length, external diameter, internal diameter, pitch, height, any combination thereof, or the like parameters.

In embodiments, the configuration of inlet manifold 110 may be configured according to the dimensional configuration of the spiral pipe 102s as determined according to at least one or more parameters selected from: number of turns, length, external diameter, internal diameter, pitch, height, any combination thereof, or the like parameters.

In embodiments, the configuration of inlet manifold 110 and in particular the positioning of divider 115 within manifold 110 may be configured and/or determined according to the dimensional configuration of the spiral pipe 102s as determined according to at least one or more parameters selected from: number of turns, length, external diameter, internal diameter, pitch, height, any combination thereof, or the like parameters.

Now referring to FIG. 9A-B showing a partial schematic illustration of panel 100 as previously described that further comprises two optional forms of vacuum module 130 according to embodiments of the present invention.

FIG. 9A shows solar panel 100 that is functionally associated with a vacuum module 130, so as to generate a vacuum environment within solar panel housing 120 of solar panel 100. In embodiments vacuum module 130 comprises a vacuum pipe 132 and vacuum valve 134 that are used to generate a vacuum within panel 100 about housing 120.

FIG. 9B shows a further optional embodiment of panel 100 that comprises a vacuum module 130 that features a venturi assembly 135. In embodiments venturi assembly is in fluid communication and continuous with vacuum pipe 132, for example a shown.

Venturi assembly 135 preferably forms a part of vacuum module 130 and comprises a venturi pipe 138 and a second vacuum valve, for example as shown. Venturi pipe 138 is preferably coupled to and in fluid communication with outlet 114 of manifold 110. Preferably, a fluids heated with panel 100 flow from panel 100 toward tank 10, along a venturi pipe 138 featuring a constriction zone segment. Adjacent to the constriction zone, downstream of the direction of flow, the venturi assembly features a second vacuum valve 136 as shown, that is in fluid communication with housing 120 of panel 100 via vacuum pipe 132, for example as shown.

In embodiments, the venturi assembly causes a low and/or negative pressure and/or vacuum to be established adjacent to the constriction zone of venturi pipe 138. The establishment of a low pressure zone adjacent to the constriction point of pipe 138, is provided by the venturi effect where the flow of a fluid from outlet 114 toward tank 10 across a venturi pipe segment 138, as shown by the directional arrow, creates the low pressure zone adjacent to vacuum pump 136. Accordingly, as fluid flows from panel 100 to tank 10, the venturi assembly 135 portion of vacuum module 130 further establishes a vacuum and/or maintains the vacuum within housing 120 of panel 100.

In embodiments the vacuum module 130 depicted in FIG. 9A shows an active vacuum establishing module where a vacuum within housing 120 of panel 100 is established. In embodiments, vacuum module 130 featuring venturi assembly 135, as shown in FIG. 9B, depicts an embodiment for passive vacuum establishment within housing 120 of panel 100, wherein the use, by way of fluid flow as fluid exit panel 100 via outlet 114 toward tank 10 establishes the vacuum within housing 120 of panel 100.

As used herein the term “about” refers to +/−10%.

The terms “comprises”, “comprising”, “includes”, “including”, “having” and their conjugates mean “including but not limited to”. The term “consisting of” means “including and limited to”. The term “consisting essentially of” means that the composition, method or structure may include additional ingredients, steps and/or parts, but only if the additional ingredients, steps and/or parts do not materially alter the basic and novel characteristics of the claimed composition, method or structure.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

In those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

While the invention has been described with respect to a limited number of embodiment, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Therefore, the foregoing is considered as illustrative only of the principles of the invention. Further, since numerous modifications and changes will readily occur to those skilled in the art, it is not described to limit the invention to the exact construction and operation shown and described and accordingly, all suitable modifications and equivalents may be resorted to, falling within the scope of the invention.

It should be noted that where reference numerals appear in the claims, such numerals are included solely or the purpose of improving the intelligibility of the claims and are no way limiting on the scope of the claims.

Having described a specific preferred embodiment of the invention with reference to the accompanying drawings, it will be appreciated that the present invention is not limited to that precise embodiment and that various changes and modifications can be affected therein by one of ordinary skill in the art without departing from the scope or spirit of the invention defined by the appended claims.

Further modifications of the invention will also occur to persons skilled in the art and all such are deemed to fall within the spirit and scope of the invention as defined by the appended claims.

Citation or identification of any reference in this application shall not be construed as an admission that such reference is available as prior art to the invention.

Section headings are used herein to ease understanding of the specification and should not be construed as necessarily limiting.

1.-28) (canceled)

29. A water heating solar panel comprising:
a) a manifold having an inlet portion and an outlet portion that are independent of one another;
b) a pipe distributer;
c) a plurality of water heating pipes configured to be in fluid communication between said manifold and said pipe distributer; and
d) a panel housing including an upper cover and a lower cover.

30. The solar panel of claim 29 further comprising a heat promoting surface.

31. The solar panel of claim 30 wherein said heat promoting surface is a light reflective surface that is disposed below said plurality of water heating pipes.

32. The solar pane of claim 29 wherein said lower cover is an insulated cover that features a plurality of air gaps.

33. The solar panel of claim 29 wherein said manifold features a divider that defines the inlet portion and outlet portion; and wherein said divider divides said manifold according to an inlet to outlet ratio of at least a 20:80 ratio and up to a 50:50 ratio.

34. The solar panel of claim 33 wherein the inlet to outlet ratio is selected from one of: 20:80, 25:75, 30:70, 35:65; 40:60, 45:55 or 50:50.

35. The solar panel of claim 29 wherein said plurality of water heating pipes are configured to be a multi-layer concentric pipe featuring: an internal water flowing lumen, an intermediate layer configured to surround said internal lumen; and an outer layer surrounding said intermediate layer.

36. The solar panel of claim 35 wherein said intermediate layer is a thermally conductive material.

37. The solar panel of claim 35 wherein said plurality of water heating pipes are provided with parameters selected from at least one of: an external diameter of from 10 mm and up to 16 mm, and/or an internal diameter of from 4 mm and up to 8 mm.

38. The solar panel of claim 35 wherein said internal lumen has a variable internal diameter along its length.

39. The solar panel of claim 38 wherein said variable internal diameter varies by about 1 mm along its length.

40. The solar panel of claim 29 wherein said panel may be coupled to at least one selected from the group comprising: a flow controller, a valve, a pressure sensitive ball valve, or a temperature sensitive wax valve.

41. The solar panel of claim 29 wherein said plurality of pipes are provided in the form of a spiral pipe or a helical pipe.

42. The solar panel of claim 41 wherein a spiral pipe assembly comprises a right handed spiral pipe and a left handed spiral pipe that are configured to cooperate with one another so as to increase overall heating surface by a factor of at least 2.

43. The solar panel of claim 29 further comprising a vacuum module for establishing a vacuum within said housing.

44. The solar panel of claim 43 wherein said vacuum module comprises a vacuum pipe and a vacuum valve in fluid communication with a housing of said solar panel.

45. The solar panel of claim 44 wherein said vacuum module further comprises a venturi assembly comprising a venturi pipe segment and a second vacuum valve.

46. The solar panel of claim 45 wherein a first end of said venturi pipe segment is in fluid communication with said outlet portion and wherein a low pressure zone of said venturi pipe segment is in fluid communication with said vacuum pipe across at least one vacuum valve.

47. The solar panel of claim 45 wherein said second vacuum valve is in fluid communication with said vacuum pipe.

48. A solar water heating system comprising a water tank and at least one solar panel according to claim 29.
